(19) United States
(12) Patent Application Publication
(10) Pub. No.: US 2022/0290700 A1
(43) Pub. Date: Sep. 15, 2022

(54) LATTICE PHONONIC SUBSURFACE MATERIALS FOR FLOW CONTROL

(71) Applicant: The Regents of the Univ. of Colorado, a body corp., Denver, CO (US)

(72) Inventors: Mahmoud Hussein, Boulder, CO (US); Sedat Biringen, Boulder, CO (US)

(21) Appl. No.: 17/753,233

(22) PCT Filed: Aug. 24, 2020
(86) PCT No.: PCT/US2020/047703

§ 371 Date: Feb. 24, 2022

Related U.S. Application Data
(60) Provisional application No. 62/891,325, filed on Aug. 24, 2019.
(60) Provisional application No. 62/891,321, filed on Aug. 24, 2019.

(51) Int. Cl. F15D 1/00; B32B 15/08; B32B 15/20

(52) U.S. Cl. CPC F15D 1/006; B32B 15/08; B32B 15/20

(57) ABSTRACT

A material for use in interacting with a flow is provided. The material comprises an interface surface adapted to move in response to a pressure associated with at least one wave in a flow exerted on the interface surface; and a subsurface feature extending from the interface surface, the subsurface feature comprising a phononic crystal or locally resonant metamaterial adapted to receive the at least one wave having the at least one frequency based upon the pressure from the flow via the interface surface and alter a phase of the at least one wave. The subsurface material comprises a lattice-structured material comprising a plurality of structural elements and a plurality of voids, and the interface surface is adapted to vibrate at a frequency, phase, and amplitude in response to the altered phase of the at least one wave. A method for interacting with a flow is also provided.

### CROSS-REFERENCE TO RELATED APPLICATIONS

This application claims the benefit of U.S. provisional application No. 62/891,321 entitled “LATTICE PHONONIC SUBSURFACE MATERIALS FOR FLOW CONTROL” and filed on 24 Aug. 2019, which is hereby incorporated by reference as though fully set forth herein.

### BACKGROUND

U.S. patent application Ser. No. 14/811,801 filed on Jul. 28, 2015 and Ser. No. 15/636,639 filed on Jun. 29, 2017 and PCT patent application nos. PCT/US15/42545 filed on Jul. 28, 2015 and PCT/US18/40114 filed on Jun. 28, 2018 and disclosed phononic subsurface materials disposed adjacent a flow surface and extending away from the flow surface in a direction away from the flow (e.g., at least generally perpendicular to the flow surface). In some instances, the subsurface material(s) were designed using concepts from phononics to control the flow. In other instances, design criteria based on a phononic metric for the subsurface phononic material and a performance criteria based on a reduction in kinetic energy in the flow and/or a reduction of drag along the surface were disclosed. Each of the listed applications are incorporated by reference herein in their entirety for all they teach and suggest.

### SUMMARY

In one implementation, a material for use in interacting with a flow is provided. The material comprises an interface surface adapted to move in response to a pressure associated with at least one wave in a flow exerted on the interface surface; and a subsurface feature extending from the interface surface, the subsurface feature comprising a phononic crystal or locally resonant metamaterial adapted to receive the at least one wave having the at least one frequency based upon the pressure from the flow via the interface surface and alter a phase of the at least one wave. The subsurface material comprises a lattice-structured material comprising a plurality of structural elements and a plurality of voids, and the interface surface is adapted to vibrate at a frequency, phase, and amplitude in response to the altered phase of the at least one wave.

In another implementation, a method for interacting with a flow is also provided. In this example, the method comprises providing an interface surface juxtaposed the flow; receiving a pressure associated with at least one wave having at least one frequency in a flow exerted on the interface surface; receiving the at least one wave via a subsurface structure extending from the interface surface; altering a phase of the at least one wave via the subsurface structure; and vibrating the interface surface at a frequency, phase and amplitude in response to the altered phase of the at least one wave. The subsurface structure comprises a lattice material comprising a plurality of structural elements and a plurality of voids.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic diagram of a flow channel with a subsurface structure incorporated into the flow channel. The subsurface structure can include a surface that functions as an interface surface with a flow in the channel or may be disposed adjacent or juxtaposed to a flexible material that serves as an interface surface and is adapted to move in response to a pressure exerted on the flexible material the surface by a fluid flowing in the flow channel.

FIG. 2A depicts example dispersion curves for a one-dimensional layered phononic crystal from which the subsurface is composed (Brillouin zone illustrated in inset) as shown in FIG. 1.

FIG. 2B depicts an example steady-Mate vibration response of the phononic crystal surface representing the interface with the flow as shown in FIG. 1.

FIG. 2C depicts an example time-averaged phase between force and displacement at the phononic crystal surface representing the interface with the flow as shown in FIG. 1.

FIG. 2D depicts an example performance metric combining amplitude and relative phase between the force and the displacement at the phononic crystal surface representing the interface with the flow as shown in FIG. 1.

FIG. 3 is a schematic drawing showing different example configurations of phononic crystals used in a phononic subsurface implementation.

FIG. 4 is a schematic drawing showing example configurations of phononic crystals and metamaterials that may be used to form a phononic subsurface.

FIG. 5 is a schematic drawing showing a plurality of example configurations of two-dimensional elastic metamaterials with one-dimensional locally resonant oscillators extending from a base material.

FIGS. 6A-6F are schematic drawings showing a plurality of example configurations of one-dimensional locally resonant oscillator geometries/shapes that extend from a base material (as shown in FIG. 5).

FIGS. 7A and 7B depicts other example configurations of two-dimensional elastic metamaterials with one-dimensional locally resonant oscillators extending from a base material—these configurations may be used to form a phononic subsurface where the plates, where appropriate, may be oriented either in parallel or perpendicular or at an angle to the surface (and to the flow).

FIGS. 8A and 8B depict yet other example configurations of two-dimensional elastic metamaterials with embedded resonant oscillators—these configurations may be used to form a phononic subsurface where the plates, where appropriate, may be oriented either in parallel or perpendicular or at an angle to the surface (and to the flow).

FIGS. 9A and 9B depict other example configurations of two-dimensional elastic metamaterials with two-dimensional locally resonant oscillators extending from a base material.

FIGS. 10A and 10B depict yet other example one-dimensional elastic metamaterials with one-dimensional locally resonant oscillators extending from a base material.

FIGS. 11A and 11B depict yet other example configurations of three-dimensional elastic metamaterials with embedded resonant oscillators.

FIGS. 12 and 13A-13B further show examples of phononic materials comprising lattice structures.

FIG. 14 shows further example 3D lattice structured phononic materials that may be used a phononic subsurfaces as described herein.

FIG. 15 shows an example triangular honeycomb lattice structure and a corresponding 2D lattice model that may be used to model the lattice structured phononic subsurface material and its response to a flow adjacent to the phononic subsurface material.

FIG. 16 shows dispersion and mode shapes of an example triangular honeycomb lattice structure such as shown in FIG. 15.

FIG. 17 shows a graph of an example frequency response for a 2D plane-strain of an embodiment of a lattice structured phononic subsurface material such as the triangular honeycomb lattice structure shown in FIG. 16.

FIG. 18 shows finite element considerations for vibrations at high frequencies.

FIG. 19 shows amplitude and phase frequency response for an example 2D lattice structure phononic subsurface material for a force F(t) imparted on the phononic subsurface structure.

FIG. 20 shows dispersion and mode shapes of an example 1D lattice structure phononic subsurface material including 1D Timoshenko beam structural elements with a square lattice having an aspect ratio of 50.

FIG. 21 shows dispersion and mode shapes of an example 1D lattice structure phononic subsurface material including 1D Timoshenko beam structural elements with a square lattice having an aspect ratio of 10.

FIGS. 22 and 23 show a 2D plane strain model for an example lattice structured phononic subsurface structure including a single square lattice unit cell.

FIG. 24 shows a static 2D plane strain model for the example lattice structured phononic subsurface structure comprising a single square lattice unit cell.

FIG. 25 is a schematic diagram of a distributed load applied to a phononic sublattice designed to provide a subsurface material adapted to affect a flow.

FIG. 26 is a schematic diagram of an example phononic sublattice structure, such as shown in FIG. 25, disposed adjacent or juxtaposed to a flow.

FIG. 27 is schematic diagram of another example phononic sublattice structure, such as shown in FIGS. 25 and 26, disposed adjacent or juxtaposed to a flow.

FIG. 28 is a schematic diagram of another example phononic sublattice structure in which the phononic sublattice structure is disposed adjacent to a flow surface adapted to interact with the flow.

FIG. 29 is a schematic diagrams of a point load and a distributed load applied to a phononic sublattice structure, such as those shown in FIGS. 25-28.

FIG. 30 shows frequency dependent amplitude, phase, and performance metric response for the lattice subsurface structure shown in FIG. 29 for a point force F(t) imparted on the lattice subsurface structure.

FIG. 31 is a schematic drawing showing a prototype turbulent channel rig that can be used for testing the performance of a an example structural subsurface material such as the example lattice substructure (labeled here as SSub) shown for the purpose of laminar flow stabilization/destabilization or turbulent flow increase or decrease in intensity of turbulence.

### DETAILED DESCRIPTION

Reduction in flow instabilities (e.g., present in a laminar or turbulent flow before a transition to a fully turbulent flow) can be measured in the reduction of kinetic energy in the flow and/or reduction of surface drag along the flow surface at the interface of the flow surface and the lattice phononic subsurface material. The flow in this context comprises the motion of a fluid medium of gas or liquid, or a gas-liquid mixture, or a gas-liquid-solid mixture, or a liquid-solid mixture, or a gas-solid mixture. The concept comprising interaction with the velocity and/or pressure fields of a flow can be used to control laminar, pre-turbulent, or turbulent flows in order to reduce local skin friction and hence to reduce drag on surfaces and bodies that move in a fluid medium of gas or liquid, a gas-liquid mixture, a gas-liquid-solid mixture, a liquid-solid mixture or a gas-solid mixture.

One example methodology for designing a lattice phononic subsurface material for reducing instabilities in a laminar, pre-turbulent, or turbulent flow is as follows. First, a unit cell of the lattice phononic subsurface material is designed and/or optimized to interact with a flow. Then, a steady-state frequency response analysis is conducted on a model representing a finite structure composed of one or more unit cells of the type designed above. The unit cells may be laid out in the direction perpendicular, or parallel, or both, to the surface (and flow). The unit cell and possibly the end design and boundary conditions of the structure are then altered until the interaction with the flow operates as desired. A performance metric is then used to evaluate the predicted performance of the phononic subsurface material as explained in more detail below. In this implementation, the performance metric is a product of the amplitude and phase of the response at the edge of a lattice subsurface exposed to a flow (see, e.g., U.S. patent application Ser. No. 14/811,801 filed on Jul. 28, 2015 and Hussein, M. I., Biringen, S., Bilal, O. R., and Kucala, A. “Flow stabilization by subsurface phonons,” Proceedings of the Royal Society A, 471, 20140928, 2015). The process can be repeated, such as until the predicted performance metric gives a negative value with the highest (or at least acceptable, predetermined or designed) possible absolute value of amplitude and/or meeting one or more design criteria for flow stabilization; or gives a positive value with the highest (or at least acceptable, predetermined or designed) possible absolute value of amplitude and/or meeting one or more design criteria for flow destabilization. The metric is evaluated at the frequency or frequency range of the flow instability that is to be controlled. The process can also be repeated to cover multiple frequencies or a contiguous range of frequencies covering the frequencies of the instabilities that the lattice phononic subsurface is designed to control.

In another example methodology, a lattice subsurface structure may be designed offline (such as using a compliance criteria as described in U.S. provisional application No. 62/891,325 entitled “STRUCTURAL SUBSURFACE MATERIAL FOR TURBULENT FLOW CONTROL” filed on Aug. 24, 2019 (attorney docket no. CU5126B-PPA1), which is hereby incorporated by reference in its entirety), and not need to design by iterations. One advantage of this approach is that the phononic subsurface material can be fully designed without carrying out any coupled fluid-structure simulations (which tend to be computationally expensive). However, a fluid-structure simulation may be conducted as a verification, especially to ensure that the level of damping (material and structural) in the phononic subsurface material is optimal and/or meets one or more design criteria.

Design and construction of materials or structures that work on the fundamental concepts from phonon physics utilizing Bragg scattering and internal resonances (separately or in combination) are provided. In various implementations, the materials or structures (which take the form of a lattice in the current implementations provided herein) can be implemented to open band gaps in their frequency responses to form stop bands to induce “out-of phasing” and, conversely, pass-bands to induce “in-phasing” in the interacting fluid flow (gases and liquids, single phase and multi-phase), as well as in flowing solids like ice and snow, they are in contact with, for the purpose of flow control. The stop-bands and pass-bands can also be designed to enhance and/or absorb energy in the fluids, advance or delay flow separation, enhance or reduce lift, reduce or enhance surface flutter and alter heat transfer within the flow by changing flow characteristics.

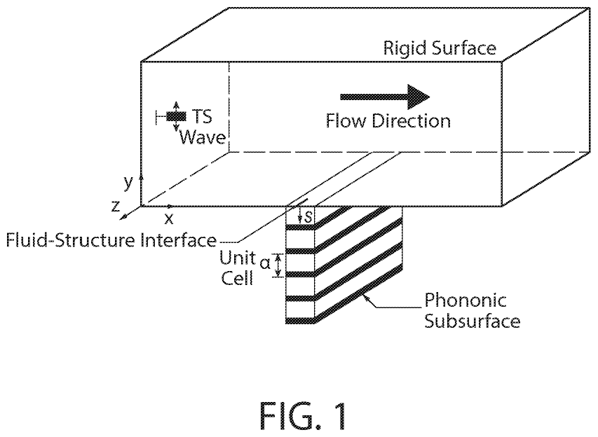

Lattice-based phononic subsurface(s) include phononic crystals designed based on the Bragg scattering principle and/or locally resonant metamaterials (also referred to as locally resonant elastic metamaterials or locally resonant acoustic metamaterials) that work on the principle of internal resonances and mode hybridization. The concept comprises the introduction of an elastic medium (phononic crystal or locally resonant metamaterial), located at one or more points or regions of interest along a surface, and extending in a manner such that its spatial periodicity is along a depth, e.g., perpendicular to the surface, at an angle to the surface, along the surface or any combination thereof. One example implementation is shown in FIG. 1, in which a segment of a surface (e.g., a bottom surface) of a flow channel with otherwise all-rigid walls is replaced with a one-dimensional (1D) elastic lattice phononic subsurface extending away from the flow surface of the flow channel. The phononic crystal shown in FIG. 1 may be replaced with other phononic crystal or locally resonant metamaterials described herein or in U.S. patent application Ser. No. 14/811,801 filed on Jul. 28, 2015 and Ser. No. 15/636,639 filed on Jun. 29, 2017 and PCT patent application nos. PCT/US15/42545 filed on Jul. 28, 2015 and PCT/US18/40114 filed on Jun. 28, 2018, which are incorporated by reference in its entirety as if fully set forth herein.

Stabilization can be accomplished within a stop band (at frequencies falling to the right of a truncation resonance) by inducing destructive interferences in the velocity and/or pressure fields of a flow that lead to attenuation of instability wave amplitudes in the flow. Conversely, flow destabilization is induced within a pass band (in certain frequency windows) by inducing constructive interferences in the velocity and/or pressure fields of a flow that amplify disturbance wave amplitudes in the flow. The flow in this context comprises the motion of a fluid medium of gas or liquid, or a gas-liquid mixture, or a gas-liquid-solid mixture, or a liquid-solid mixture, or a gas-solid mixture. The same concept comprising destructive and/or constructive interference of the velocity and/or pressure fields of a flow can also be used to control turbulent flows in order to reduce or enhance local skin friction and hence to reduce or enhance drag on surfaces and bodies that move in a fluid medium of gas or liquid, a gas-liquid mixture, a gas-liquid-solid mixture, a liquid-solid mixture or a gas-solid mixture. The same concept comprising destructive and/or constructive interference in the velocity and/or pressure fields of a flow is also utilized for enhancing/controlling the degree of mixing in laminar/turbulent liquid-gas mixtures, mixtures of different liquids, mixtures of different gases, mixtures of liquid-gas-solid, mixtures of liquid-solid, mixtures of gas-solid and combustibles, enhancing or attenuating heat transfer rates within the flow, advancing or delaying separation, enhancing or reducing lift, and/or reduce or enhance surface flutter.

One example methodology for designing a lattice-based phononic subsurface for stabilizing an unstable wave at a particular frequency is as follows. First, the unit cell of the phononic subsurface is designed and optimized to exhibit a stop band (band-gap) encompassing the frequency of the instability wave. Then, a steady-state frequency response analysis is conducted on a model representing a finite structure composed of one or more unit cells of the type designed above. The unit cells may be laid out in the direction perpendicular, or parallel, or both, to the surface (and flow). The unit cell and possibly the end design and boundary conditions of the structure are then altered until the periodicity truncation resonance that is closest to the instability wave frequency is located as close as possible and to the left of the instability wave frequency. A performance metric is then used to evaluate the predicted performance of the phononic subsurface as explained in more detail below. The process is repeated until the predicted performance metric gives a negative value with the highest possible absolute value.

One advantage of this approach is that the lattice phononic subsurface can be fully designed without carrying out any coupled fluid-structure simulations (which tend to be computationally expensive). However, a fluid-structure simulation may be conducted as a verification, especially to ensure that the level of damping (material and structural) in the phononic subsurface is optimal.

The same process as the one mentioned above may be adopted for destabilization, with the exception that (1) the unit cell in this case is designed to exhibit a pass band around the frequency of interest and (2) the structure overall (including the unit cell layout) is designed such that the frequency of interest matches a pass-band resonance frequency.

While the above descriptions are concerned with the manipulation of a single frequency (unstable wave for stabilization or vice versa), the methodology can be extended to cover particular frequencies and their harmonics (which is relevant to nonlinear instabilities and transition problems) and a range of frequencies (which is relevant to turbulence problems).

One goal of turbulent drag reduction is to destroy a sequence of events leading to turbulence by modifying the high-low velocity near-wall streak arrangement and/or to modify the streamwise vorticity pairs by altering a phase between v- and w-fluctuation velocities and shut-off a bursting process thus preventing or reducing the production of turbulent kinetic energy. It is also possible to reduce turbulent kinetic energy by decreasing its production by phase modification of u-v-components that are responsible for extracting energy from a mean flow over a wide frequency bandwidth. On this basis, a phononic subsurface may be tasked to decrease the intensity of energy containing eddies both by preventing or delaying their genesis, and also by reducing their effectiveness to extract energy from the mean motion. For this function to be passively realized, a phononic subsurface unit cell design process may be informed by the results of a series of turbulent flow simulations spanning a variety of conditions. For example, a frequency range of a spectrum of energy containing eddies and bursting frequency range may be used in designing a subsurface phononic material. With this information, a phononic subsurface may be designed focusing on v-field dephasing across prescribed frequency ranges with a particular design weight assigned to each of the flow mechanisms. This design may be tested in a coupled fluid-structure simulation, and the process repeated following a different weight.

In both high-pressure and low-pressure turbine blade passages, using any working fluid in liquid and/or gas phase, there may be a need to cool the blade material on both the suction and the pressure side of the passage. This can be achieved by passing a cooling fluid along turbine blades to cool the boundary layer fluid on the blade surfaces by convection. For efficient cooling, it is desirable to have high convection heat transfer rates which are possible when the flow is locally turbulent. This is a challenging issue because on the pressure side of the blade passage, flow relaminarizes and the convection heat transfer rates are low. Phononic materials/subsurfaces can be designed to locally enhance mixing by destabilizing the flow into turbulence over those regions of the blade passage where working fluid temperatures are high.

Flow and Solid Surface Control

In some implementations, for example, lattice-based phononic subsurfaces can be used in applications, such as, but not limited to any air, sea and land vehicles, manned and unmanned (drones), water and wind turbine blades, propellers, fans, steam and gas turbines blades, among other applications, for the purposes of drag reduction, drag enhancement, turbulence reduction, turbulence enhancement (e.g., in fluid mixing), linear instability suppression, nonlinear instability suppression, transition delay/promotion, enhanced maneuverability, lift enhancement; heat transfer control (enhancement and/or reduction), noise control, vibration control, flutter avoidance, inducing surface movement in all three coordinate directions; separation delay, among others.

Fluids

Examples of fluids that may be used with lattice-based phononic subsurfaces such as described herein, include, but are not limited to, the following: all fluids, gases, liquids, single and multi-phase, mixtures, and the like. In one particular implementation, for example, air, water, oil, natural gas, sewage or other fluids may be used with phononic subsurfaces. Fluids can exist at room temperature, lower than room temperature, higher than room temperature. Applications cover static fluids, incompressible fluids, subsonic, transonic, supersonic, hypersonic flow regimes; laminar, turbulent and transitional flow regimes; smooth surfaces, surfaces with surface roughness—appearing naturally and by transition; instability, transition and turbulence—instigated naturally, with acoustic excitations, with finite-size roughness elements of any shape, plant canopies, others; by-pass instabilities, transition and turbulence.

Flow control applications cover all flow fields. These include (but are not limited to) external and internal flows, and their various combination; all flow fields are included.

External flows: Flows over aircraft wings (passenger aircraft, fighter aircraft, tankers, military aircraft, all fixed wing aircraft, rotary wing aircraft, helicopters, vertical take-off aircraft, re-usable space vehicles, aircraft with jet engines, aircraft with propellers, ship-based Navy aircraft); flow control in wing-body junctions, over fuselages, in and around aircraft engine inlets, turbines, over turbine blades, blade passages, wind turbine blades; wings of any cross-section, symmetric, non-symmetric, with and without camber, all wing, airfoil and hydrofoil profiles (including NACA and NASA airfoils), delta wings, folding wings, retractable wings, wing appendages, high-lift devices. Flows around sea vehicles including ships (battleships, cruise ships, cargo ships-manned), tankers, carriers, racing boats, sailing boats, unmanned boats submarines (manned and unmanned), deep-sea vehicles, hovercrafts, jet skis, water boards, among others. Flows around wind turbine blades of any type and water and steam turbines of any type.

Internal flows (of any fluid, gas and/or liquid): Flows in pipes, open or closed (channels), of any cross-sectional shape, and length, and at any temperature, and of sudden or gradual expansion; pipes of circular, square, elliptic, rectangular, triangular shapes, of any material; pipes with surface heating and/or cooling, pump-driven, gravity driven, buoyancy-driven. Pump impellers, steam turbines, pump and turbine inlet and outlet passages, flows over their blades.

The applications further cover ships, ship hulls, ship propellers, passenger ships, cruise ships, military ships of all kinds, sizes and uses, ordinance deployed in air and sea faring military manned and/or unmanned vehicles, speed boats, race boats, sail boats of all kind, used for pleasure, transportation, cargo, racing. Snow vehicles, alpine and cross-country skis, snow boards, paddle boats, wind surfing boards, parachute (ski) surfing boards, swim suits, skates, skate boards, water skiing boards.

Any solid surface that is made of any material may be used in the application of the key concept, including (but are not limited to) aluminum, plastic/polymer (all types), titanium, steel, copper, cement, rare earth, high-temperature resistant ceramics; all materials (natural or synthetic) that are in contact with any fluid are included in the scope of applications mentioned in this disclosure.

### Lattice Phononic Subsurface

Phononic subsurface material(s) provided herein may comprise lattice materials comprising materials such as, but not limited to, such as metal, rubber, polymer, ceramic, wood, or the like. The concept comprises the introduction of an elastic medium (in this case, the lattice phononic subsurface material), located at one or more points or regions of interest along and/or forming a solid flow surface, and extending away from the solid flow surface, e.g., perpendicular to the surface, at an angle to the surface, along the surface or any combination thereof. One example implementation is shown in FIG. 1, in which a segment of a surface (e.g., a bottom surface) of a flow channel with otherwise all-rigid walls is replaced with a one-dimensional (1D) elastic lattice phononic subsurface material extending away from the flow surface. The phononic subsurface material shown in FIG. 1 may be any lattice phononic subsurface material and is not limited to the phononic crystal or locally resonant metamaterials described in the previously incorporated United States and PCT published patent applications.

In some implementations, for example, lattice phononic subsurface(s) may comprise materials, such as but not limited to phononic crystals designed based on the Bragg scattering principle and/or locally resonant metamaterials (also referred to as locally resonant elastic metamaterials or locally resonant acoustic metamaterials) that work on the principle of internal resonances and mode hybridization. The concept comprises the introduction of an elastic medium (phononic crystal or locally resonant metamaterial), located at one or more points or regions of interest along a surface, and extending in a manner such that its spatial periodicity is along a depth, e.g., perpendicular to the surface, at a non-perpendicular angle to the surface, along the surface or any combination thereof.

In other example implementations, lattice phononic subsurface(s) may comprise other, materials, such as but not limited to metal, rubber, polymer, ceramic, wood, or the like. In certain implementations where a flow may create a significant amount of heat, such as in a hypersonic flow, heat resistant materials such as metals (e.g., titanium) or ceramics may be particularly advantageous.

As described above, the concept comprises the introduction of an elastic medium (the lattice phononic subsurface material), located at one or more points or regions of interest along a flow surface, and extending away from the flow surface, e.g., perpendicular to the surface, at an angle to the surface, along the surface or any combination thereof. One example implementation is shown in FIG. 1, in which a segment of a surface (e.g., a bottom surface) of a flow channel with otherwise all-rigid walls is replaced with a one-dimensional (1D) elastic lattice-based phononic subsurface material extending away from the flow surface.

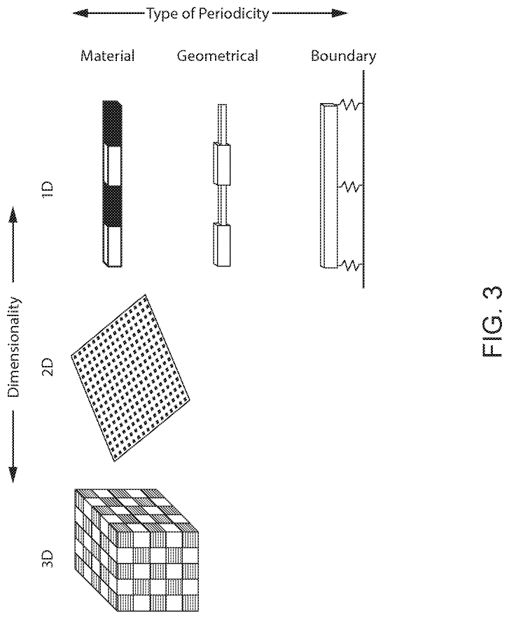

A lattice-based phononic subsurface could be made of a phononic crystal (periodic composite material) and/or a locally resonant metamaterial (material with embedded or attached local resonators which can be laid our periodically or non-periodically). In both cases, a material variation or variation of geometric feature could extend in a one-, two- or three-dimensional sense, and could comprise one, two or more constituent materials. FIG. 3 demonstrates different example configurations of phononic crystals used in a phononic subsurface implementation. The various examples include one-dimensional (1D), two-dimensional (2), and three-dimensional (3D) example configurations.

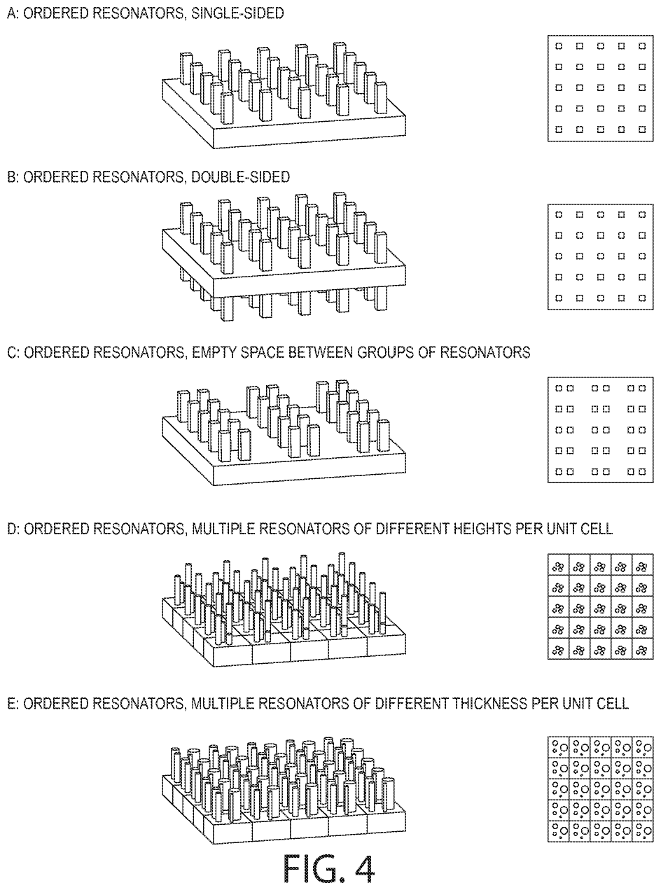

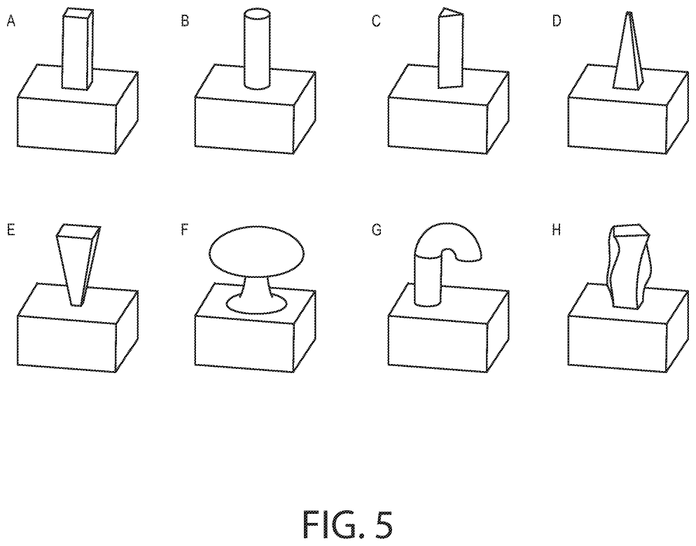

FIGS. 4-11 demonstrate different possible configurations of locally resonant metamaterials comprising the phononic subsurface. FIG. 4, for example, shows schematic diagrams of example configurations of phononic crystals and metamaterials that may be used to form a phononic subsurface. In the example labeled as A, for example, different perspective views of one implementation of a plate including a generally two-dimensional (2D) uniform, periodic array of equal-sized pillars disposed on a single surface (e.g., a top surface) of the plate is shown. Although the pillars are shown example A of FIG. 4 to have a square cross-section, they can have any other cross-sectional shape such as rectangle, circle, oval, triangle, polygon or other regular or irregular cross-sectional shape. In an example labeled as B, different perspective views of another implementation of a generally two-dimensional (2D) plate including a periodic, uniform array of equal-sized, pillars disposed on two sides/surfaces (e.g., top and bottom surfaces) of the plate is shown. In this implementation, the size of the pillars on a first side of the plate (e.g., top pillars) could be equal to or different than the size of the pillars on a second side of the plate (e.g., bottom pillars). In addition, although the pillars are shown in example B to have a square cross-section, they can have any other cross-sectional shape such as rectangle, circle, oval, triangle, polygon or other regular or irregular cross-sectional shape. In an example labeled as C, for example, different perspective views of another implementation of a generally two-dimensional (2D) plate with a periodic array of equal-sized pillars disposed on a first surface of the plate (e.g., on a top surface) with an empty row appearing every n number of rows (e.g., every third row in the implementation shown in FIG. 4, example C). Other distributions of full and empty rows, and columns, could also be employed. In an example labeled as D in FIG. 4, different perspective views of another implementation of a generally two-dimensional plate with a periodic array based on a multi-pillared unit cell having pillars with different heights is shown. In the particular example, each repeated unit cell has multiple pillars each of a different height but the same cross-sectional area and/or shape. In a different implementation, each repeated unit cell could have multiple pillars of different heights and also different cross-sectional areas. While in this configuration, there are four pillars in each unit cell, other configurations could include a larger or smaller number of pillars per unit cell, distributed on only one side or both sides of the thin film. different perspectives of a fifth implementation of a generally two-dimensional plate with a periodic array based on a multi-pillared unit cell having pillars with different cross-sectional areas. In the particular example labeled as E in FIG. 4, for example, each repeated unit cell has multiple pillars each of a different cross-sectional area but the same height and/or shape. In a different implementation, each repeated unit cell could have multiple pillars of different cross-sectional areas and also different heights and/or shapes. While in this configuration, there are four pillars in each unit cell, other configurations could include a larger or smaller number of pillars per unit cell.

FIG. 5 depicts a plurality of example configurations of two-dimensional elastic metamaterials with one-dimensional locally resonant oscillators extending from a base material. These configurations may be used to form a phononic subsurface where the plates, where appropriate, may be oriented either in parallel or perpendicular or at an angle to the surface (and to the flow).

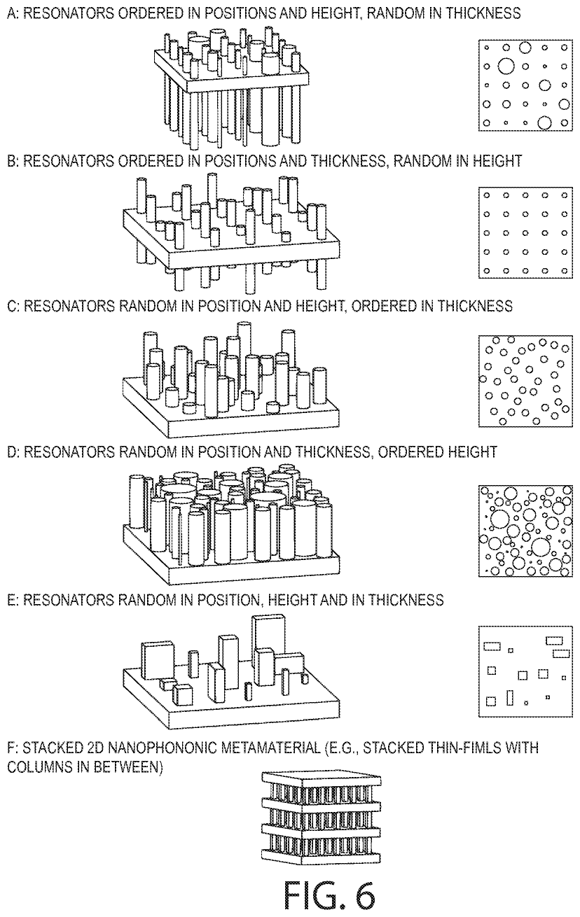

FIGS. 6A-6F depict a plurality of example configurations of one-dimensional locally resonant oscillator geometries/shapes that extend from a base material (as shown in FIG. 5).

FIG. 6A shows different perspective views of a sixth implementation of a generally two-dimensional (2D) plate including a two-dimensional (2D) periodic array of pillars disposed on a first and second surface of the plate (e.g., on a top surface and a bottom surface of the plate) in which a thickness (e.g., diameter) of the pillars vary randomly across different locations on the surface of the plate. In this implementation, the pillars on each side have same height, and the height of each pillar at the top is different than at the bottom. In another implementation, the height of each pillar at the top could be the same as at the bottom. Although pillars are shown on two sides in FIG. 6A, another implementation may have a similar configuration of pillars but on a single side only.

FIG. 6B shows different perspective views of a seventh implementation of a generally two-dimensional (2D) plate including a two-dimensional (2D) periodic array of pillars disposed on a first and second surface of the plate (e.g., on a top surface and a bottom surface of the plate) in which a height of the pillars vary randomly across different locations on the surface of the plate. In this implementation, the pillars on each side have the same thickness (e.g., diameter), and the thickness of each pillar at the top is the same than at the bottom. In another implementation, the thickness of each pillar at the top could be different than at the bottom. Although pillars are shown on two sides in FIG. 6A, another implementation may have a similar configuration of pillars but on a single side only.

FIG. 6C shows different perspective views of an eighth implementation of a generally two-dimensional (2D) plate including pillars disposed on a single surface (e.g., on a top surface) and whose positions and heights are random while their thicknesses are all the same. Although pillars are shown on a single side in FIG. 6C, another implementation may have a similar configuration of pillars but on two surfaces of a plate.

FIG. 6D shows different perspective views of an ninth implementation of a generally two-dimensional (2D) plate including pillars disposed on a single surface (e.g., on a top surface) and whose positions and thicknesses are random while their heights are all the same Although pillars are shown on a single side in FIG. 6D, another implementation may have a similar configuration of pillars but on two surfaces of a plate.

FIG. 6E shows different perspective views of a tenth implementation of a generally two-dimensional plate including a random (i.e., non-periodic) array of pillars on a single surface (e.g., on a top surface) with the thickness (e.g., diameter), shapes and heights of the pillars varying randomly across the different sites. Although pillars are shown on a single side in FIG. 6E, another implementation may have a similar configuration of pillars but on two surfaces of a plate.

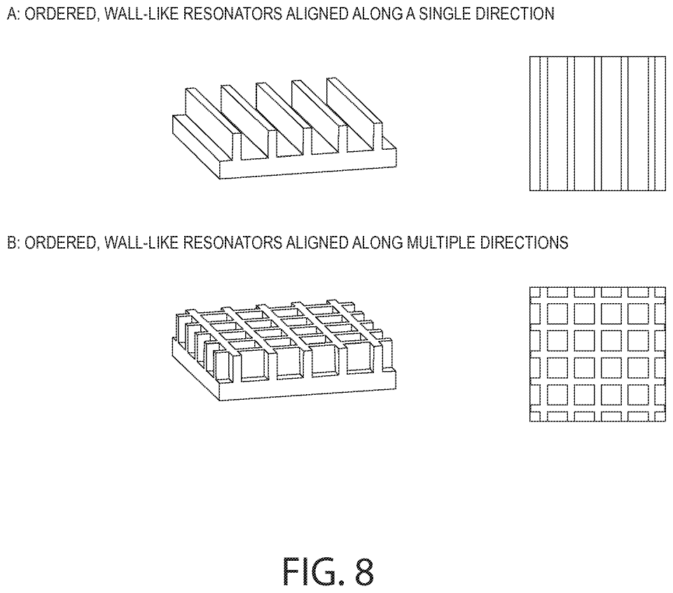

FIG. 6F shows a configuration of an eleventh implementation based on a vertical stacking of the of the pillared plate shown in FIG. 4A. The different features shown in other figures such as pillar spacing (see, for example, FIG. 4C), multi-pillar unit cell (see, for example, FIGS. 4D and 4E), walled configuration (see, for example, FIGS. 8A and 8B and their corresponding descriptions) and random pillars (see, for example, FIGS. 6A and 6D) may also apply to this vertical stacking configuration. While the figure shows, as an example three layers of pillared thin films stacked on top of each other, the number of layers of pillared thin films stacked could vary.

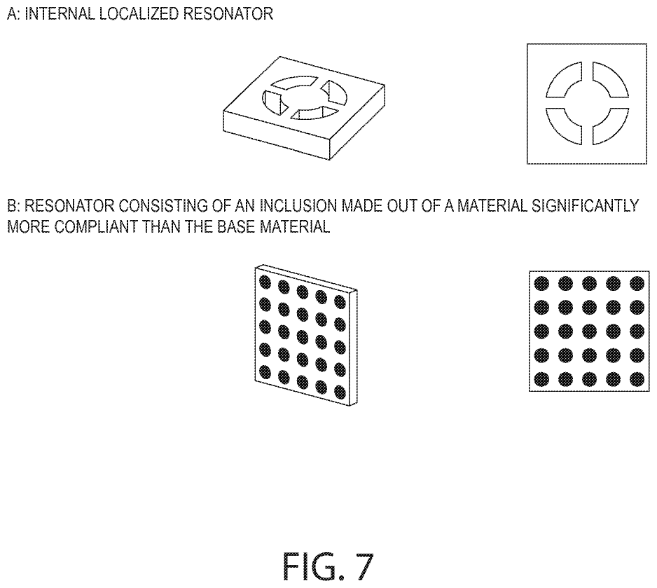

FIGS. 7A and 7B depicts other example configurations of two-dimensional elastic metamaterials with one-dimensional locally resonant oscillators extending from a base material—these configurations may be used to form a phononic subsurface where the plates, where appropriate, may be oriented either in parallel or perpendicular or at an angle to the surface (and to the flow). In a first example in FIG. 7A, different perspective views of another implementation of a generally two-dimensional plate including a bridged structure having a central cylinder supported by thin arms (e.g., beams) are shown. In this implementation, for example, the unit cell may be repeated to form a periodic or non-periodic array. The central cylinder (which could be of the same material as the main body of the thin film, or a heavier material) acts as a local oscillator/resonator in this configuration. Other shapes for oscillators/resonators in this configuration (e.g., square cylinder, sphere, others) may be employed, and the supporting arms also could have other shapes, number and orientations. This configuration concept could also be realized in the form of a 2D thick plate-like material with each oscillator/resonator taking the shape of a cylinder, or sphere or other shape.

In another shown in FIG. 7B, different perspective views of yet another implementation of a generally two-dimensional plate with a periodic array of circular inclusions comprising a highly complaint material (i.e., a material that is significantly less stiff than the material from which the main body of the thin film is made). In this particular implementation, for example, each inclusion of a compliant material in this configuration may act as an oscillator/resonator (i.e., similar to each pillar in FIG. 4A). Other shapes and sizes for the inclusions may also be adopted. The sites of the compliant inclusions may be ordered in a periodic fashion (as shown) or may be randomly distributed (as in FIGS. 6C and 6D). Similarly, the size of each inclusion may be uniform or may vary in groups (as in FIGS. 4D and 4E) or vary randomly.

FIGS. 8A and 8B depict yet other example configurations of two-dimensional elastic metamaterials with embedded resonant oscillators—these configurations may be used to form a phononic subsurface where the plates, where appropriate, may be oriented either in parallel or perpendicular or at an angle to the surface (and to the flow). FIG. 8A shows different perspective views of a fourteenth implementation of a generally two-dimensional (2D) plate including a one-dimensional (1D) periodic array of equal-sized walls disposed on a first surface of the plate (e.g., a top surface of the plate). In this particular implementation, each wall acts as an oscillator/resonator representing a 2D version of a pillar. The walls have a uniform cross section along the length, but other configurations could have a periodically or non-periodically varying cross-section along the length of the wall. Although walls are shown on a single side in FIG. 8A, another implementation may have a similar configuration of walls but on two surfaces of a plate.

FIG. 8B shows different perspective views of a fifteenth implementation of a generally two-dimensional (2D) plate including a two-dimensional (2D) periodic array of equal-sized or different sized walls disposed on a first surface of the plate (e.g., a top surface of the plate). In this particular implementation, each wall acts as an oscillator/resonator representing a 2D version of a pillar. Each wall has a uniform cross section along the length, but other configurations could have a periodically or non-periodically varying cross-section along the length of each wall. The thickness of the vertical walls could be different than the thickness of the horizontal walls. Although walls are shown on a single side in FIG. 8B, another implementation may have a similar configuration of walls but on two surfaces of a plate.

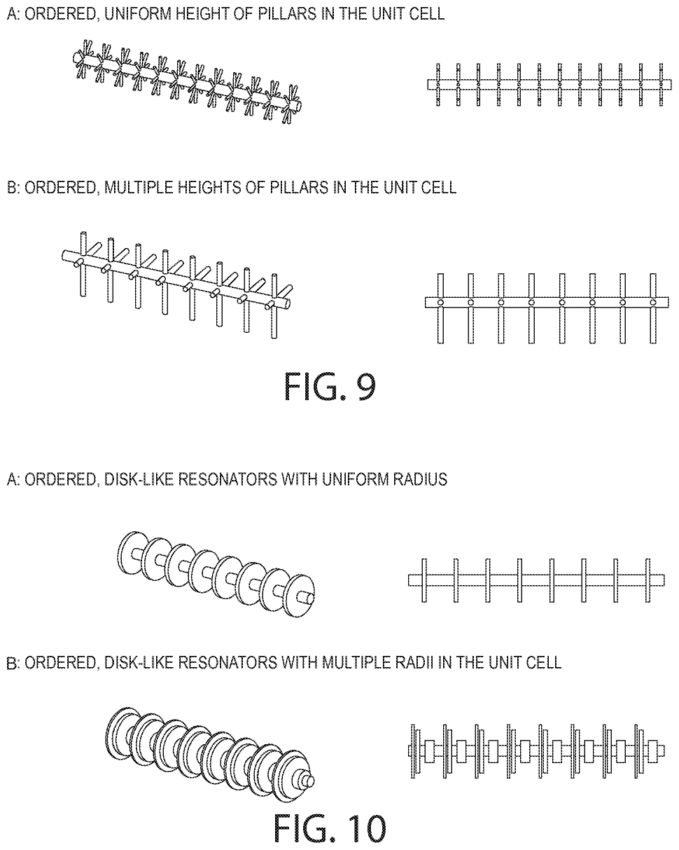

FIGS. 9A and 9B depict other example configurations of two-dimensional elastic metamaterials with two-dimensional locally resonant oscillators extending from a base material. These configurations may be used to form a phononic subsurface where the plates, where appropriate, may be oriented either in parallel or perpendicular or at an angle to the surface (and to the flow). FIG. 9A show different perspective views of a sixteenth implementation of a generally one-dimensional (1D) wire, rod, column or beam medium including a cyclic periodic array of equal-sized pillars disposed along the circumference of the main body medium. In this particular implementation, each pillar acts as an oscillator/resonator. In other implementations, the pillars may have other shapes. While in this configuration, eight pillars protrude at each lattice site, other configurations could include a larger or smaller number of pillars per lattice site.

FIG. 9B show different perspective views of a seventeenth implementation of a generally one-dimensional (1D) wire, rod, column or beam medium including a cyclic distribution of pillars of different heights disposed along the circumference of the main body medium. In this particular implementation, each pillar acts as an oscillator/resonator. In other implementations, the pillars may have other shapes. While in this configuration, four pillars protrude at each lattice site, other configurations could include a larger or smaller number of pillars per lattice site. Furthermore, in other implementations, the radial distribution of the pillars could be random. Furthermore, in other implementations, the heights of the pillars and/or shapes and/or thicknesses could be random along both the radial and axial directions.

FIGS. 10A and 10B depict yet other example one-dimensional elastic metamaterials with one-dimensional locally resonant oscillators extending from a base material. These configurations may be used to form a phononic subsurface where the rods may be oriented perpendicular or at angle to the surface (and to the flow), similar to the relative orientation between the flow and the phononic material shown in FIG. 1. FIG. 10A shows different perspective views of another implementation of a generally one-dimensional (1D) wire, rod, column or beam medium including a one-dimensional (1D) periodic array of cylinders disposed along the axis of the main body medium. In this particular implementation, each cylinder acts as an oscillator/resonator. In other implementations, the cylinders may have other shapes.

FIG. 10B show different perspective views of a nineteenth implementation of a generally one-dimensional (1D) wire, rod, column or beam medium including a one-dimensional (1D) periodic array where each unit cell consists of multiple cylinders of different diameters and/or thicknesses disposed along the along the axis of the main body medium. In this particular implementation, each cylinder acts as an oscillator/resonator. In other implementations, the cylinders may have other shapes. While in this configuration, there are three cylinders in each unit cell, other configurations could include a larger or smaller number of cylinders per unit cell. Furthermore, in other implementations, the size, shape and positioning of the cylinders along the axis of the main body may be random.

FIG. 5 shows a variety of shapes and designs for a pillar. Any of these designs, or other shapes that would allow the pillar to function as an oscillator/resonator, may be applied in conjunction with the numerous design concepts/features shown FIGS. 4, 6 and 9.

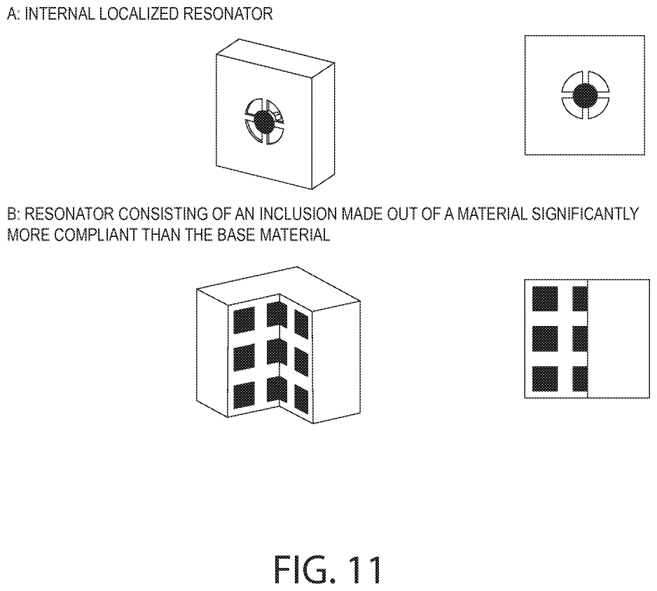

FIGS. 11A and 11B depict yet other example configurations of three-dimensional elastic metamaterials with embedded resonant oscillators. In various implementations, these configurations may be used to form a phononic subsurface where the periodic features may be oriented in any direction with respect to the surface (and the flow). FIG. 11A shows different perspective views of yet another implementation of a 3D material configuration including a bridged structure having a central sphere supported by thin arms (e.g., beams). In this implementation, for example, the unit cell may be repeated to form a periodic or non-periodic array. The central sphere (which could be of the same material as the main body of the thin film, or a heavier material) acts as a local oscillator/resonator in this configuration. Other shapes for oscillators/resonators in this configuration (e.g., cubic sphere, cylinder, others) may be employed, and the supporting arms also could have other shapes, number and orientations. In analogy to the configuration shown in FIG. 11A (which is a 2D version), the sites of the local resonators may be ordered in a periodic fashion (as shown) or may be randomly distributed.

FIG. 11B shows a 3D material configuration with a periodic array of cubic inclusions comprising a highly complaint material (i.e., a material that is significantly less stiff than the material from which the main body is made). The compliant material in this configuration acts as an oscillator/resonator (i.e., similar to the pillars in FIG. 4A). Other shapes for the inclusions may be adopted. In analogy to the configuration shown in FIG. 7B (which is a 2D version of FIG. 11B), the sites of the compliant inclusions may be ordered in a periodic fashion (as shown) or may be randomly distributed. Similarly, the size of each inclusion may be uniform or may vary in groups or vary randomly.

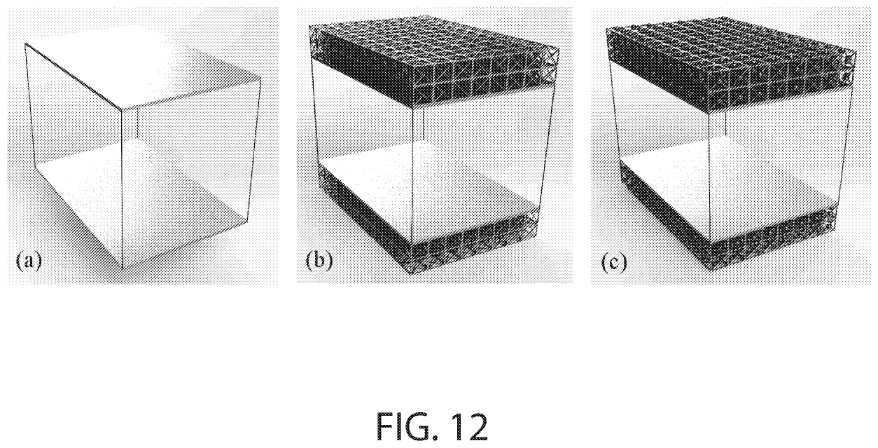

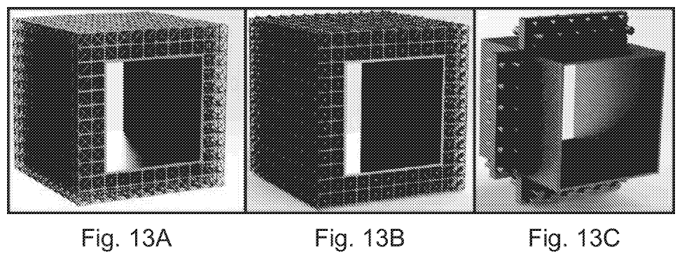

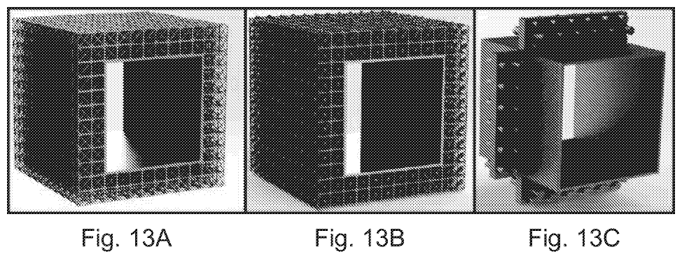

FIGS. 12 and 13A-13B further show examples of phononic materials comprising lattice structures. The lattice structures, in these embodiments comprise a plurality of structural elements (e.g., beams, rods, bars, etc.) and voids/holes, and in some cases added masses to invoke local resonances. The lattice structure disposed adjacent the flow exhibits band gaps for interacting with the flow. The structural elements and voids may comprise a fully or partially periodic phononic material.

In various implementations, phononic materials are used in or adjacent to a surface that interacts with a fluid (i.e., liquid and/or gas and/or flowing solid) flow. As described above, phononic materials refer to phononic crystals and/or locally resonant metamaterials. Phononic crystals, which are spatially periodic, include materials designed based on the Bragg scattering principle. Locally resonant metamaterials, which are not necessarily spatially periodic, include those that work on the principle of internal resonances and mode hybridization. The concept comprises the introduction of an elastic medium (e.g., a phononic crystal and/or locally resonant metamaterial), located at one or more points or regions of interest along a surface, and, in one implementation, extending in a manner such that its spatial periodicity (or generally the direction of elastic wave propagation) is along a depth, e.g., at least generally perpendicular or at an angle to the surface, at least generally along the surface or both. The terms one-dimensional (1D), two-dimensional (2D) and three-dimensional (3D) are used herein to describe both the characteristics of various base material configurations as well as the shape, size, orientation, material composition and/or location/distribution of material/geometrical interfaces or local oscillators/resonators in a locally resonant metamaterial. A base material, for example, may be described as a one-dimensional (1D) base material in the shape of a wire or rod or column that extends, with the exception of other dimensions, in a generally single dimension. Similarly, a base material, such as a thin-film/membrane/sheet or plate-shaped base material may be described as a two-dimensional (2D) structure, with the exception of other dimensions, that extends in two dimensions. Also, a different base material, such as a bulk material, may be described as a three-dimensional (3D) base material. Similarly, local oscillators/resonators, such as pillars shown in FIG. 4 may also be described with respect to one-, two- or three-dimensional structures as described herein with reference to those figures.

In one implementation, lattice phononic subsurfaces in the form of pillars are positioned periodically along one or both free surfaces of a plate base material. While the pillars in principle need not be arranged periodically for the hybridization effect to take root (the relaxation of the periodicity requirement is an advantage from the point of view of design/fabrication flexibility and insensitivity to geometric variations), the periodic positioning of the pillars in this particular implementation (1) provides an efficient way to compactly arrange the pillars, (2) allows for a systematic way to theoretically analyze, assess and design the locally resonant metamaterial, and (3) provides an additional mechanism for control of interface phasing and amplitude, namely, by Bragg scattering.

In another implementation, multiple lattice phononic subsurfaces pillar local oscillators/resonators are used on one or both free surfaces of a base thin-film material with each including a unique (distinct) height and/or cross-sectional area (see, for example, FIG. 3). In this implementation, utilization of multiple pillars (above and/or below the thin film), each of which has a distinct geometrical dimension (in terms of the height and/or the cross-sectional area) provides multiple distinct resonance sets, and the more resonant sets the more couplings/hybridizations/interactions that take place across the spectrum and this in turn leads to a richer design space for the performance metric.

One example implementation is shown in FIG. 1 in which a segment of a bottom surface of a flow channel with otherwise all-rigid walls is replaced with a one-dimensional (1D) lattice phononic subsurface material. In this particular implementation, the flow channel comprises a plurality of walls, such as the four walls shown, and having a generally rectangular cross-section. In other implementations, the flow channel may comprise any shape such as having a generally circular, elliptical, square, polygon or other cross-section. The flow channel may also include varying dimensions, such as a narrowing or expanding flow channel.

In the implementation shown in FIG. 1, for example, a flow direction of a fluid flowing through the flow channel flows in a first direction as shown by the arrow. A Tollmien-Schlichting (TS) wave propagates through the flow channel in the first direction. The flow channel includes a plurality of rigid surfaces defining the flow channel disposed within an inner boundary formed by the rigid surfaces. In one or more locations the rigid surface is replaced by the one-dimensional (1D) elastic phononic crystal as shown in FIG. 1. In this implementation, the one-dimensional lattice phononic subsurface material includes a plurality of unit cells each of length a disposed in a stacked configuration extending in a depth direction, d, which in this implementation is generally perpendicular to a rigid surface of the flow channel along which a fluid flows in the flow channel.

A single unit cell of the lattice phononic subsurface structure, in this implementation comprises a first layer and a second layer of different Young's modulus, density and layer thickness disposed adjacent to each other. In one example implementation, for example, the first layer may include a polymer, such as ABS, and the second layer may include a metal material, such as aluminum. However, these are merely examples and other materials are contemplated.

In another example implementation, FIG. 1 includes a flow channel implementation in which a surface of a flow channel (e.g., the bottom surface shown in FIG. 1) includes a flexible material that may move in response to a pressure exerted on the surface by a fluid flowing in the flow channel. A one-dimensional (1D) lattice phononic subsurface material is disposed outside the flexible surface of the flow channel. Movement of the flexible surface correspondingly causes movement in an interface surface of lattice phononic subsurface material.

In this particular implementation, the flow channel comprises a plurality of walls, such as the four walls shown, and having a generally rectangular cross-section. In other implementations, the flow channel may comprise any shape such as having a generally circular, elliptical, square, polygon or other cross-section. The flow channel may also include varying dimensions, such as a narrowing or expanding flow channel.

In the implementation shown in FIG. 1, for example, a flow direction of a fluid flowing through the flow channel flows in a first direction as shown by the arrow. A Tollmien-Schlichting (TS) wave propagates through the flow channel in the first direction. The flow channel includes a plurality of surfaces defining the flow channel disposed within an inner boundary formed by the surfaces. In this implementation, at least one of the surfaces comprises a flexible surface that interacts with the one-dimensional (1D) lattice phononic subsurface material as shown in FIG. 1. In this implementation, the one-dimensional lattice phononic subsurface material includes a plurality of unit cells each of length a disposed in a stacked configuration extending in a depth direction, d, which in this implementation is generally perpendicular to a rigid surface of the flow channel along which a fluid flows in the flow channel.

A single unit cell of the lattice phononic subsurface material, in this implementation again comprises a first layer and a second layer of different Young's modulus, density and layer thickness disposed adjacent to each other. In one example implementation, for example, the first layer may include a polymer, such as ABS, and the second layer may include a metal material, such as aluminum. However, these are merely examples and other materials are contemplated.

The lattice phononic subsurface material(s) interact with and alter phasing of waves in the flow. The interactions, for example, may increase stability and/or instability in the flow depending upon design. Phononic materials and structures including phononic materials may be designed and constructed utilizing fundamental concepts from phonon physics including Bragg scattering and internal resonances (separately or in combination) to form a band structure in their frequency responses, comprising stop bands (also known as band gaps) and pass bands (also known as bands). The band structure, for example, may form stop bands to induce “out-of phasing” and, conversely, pass-bands to induce “in-phasing” in the interacting fluid flow (gases and liquids, single phase and multi-phase), as well as in flowing solids like ice and snow, that are in contact directly with the phononic material(s) or indirectly when the phononic material(s) is/are located behind a flexible substrate/surface skin for the purpose of flow control. When a phononic material(s) is laid out in a manner adjacent to a surface (for example, underneath or behind a surface), the present application refers to it as a “phononic subsurface.” The stop-bands and pass-bands, along with the structural resonance characteristics, can also be designed to enhance and/or absorb energy in the fluids, enhance or reduce lift, advance or delay separation, alter heat transfer, reduce or enhance flutter or increase or decrease turbulence.

Example tenets pertaining to the theory/technique are described in Hussein Mich., Biringen S, Bilal Oreg., Kucala, A. Flow stabilization by subsurface phonons. Proc. R. Soc. A 471: 20140928 and in further detail below.

Designing a lattice phononic subsurface material can be performed such that its phase relation is negative at the frequency of the flow wave in order to induce stabilization, or positive at that frequency in order to induce destabilization. This phase relation may be obtained, for example, by simulating vibrations in the phononic material in a separate ‘offline’ calculation, with identical boundary conditions to the planned coupled fluid/structure configuration, and correlating between the phase of the excitation and that of the response at the part of the lattice phononic subsurface material or structure that will be exposed to the flow, which is the interface or surface. This correlation can be taken (integrated) over an extended scan of time in order to ensure a steady state representation of the strength (positive or negative) of the frequency-dependent phase function.

The response amplitude of the interface or surface, or in general the part of the material that will be exposed to the flow, can be designed to be as high as possible (e.g., within a realm of small, infinitesimal vibrations) at the frequency of a flow wave (or spectra of waves) of interest in order for the out-of-phasing or in-phasing effects mentioned above to take effect.

In order to combine both the phase and amplitude effects together, a ‘performance metric’ may be devised that is the product of these two frequency-dependent quantities, the phase and the amplitude. At the frequency of the flow wave, the following results are expected:
High absolute value of negative performance metric—strong stabilization
Low absolute value of negative performance metric—weak stabilization
High absolute value of positive performance metric—strong destabilization
Low absolute value of positive performance metric—weak destabilization

Since the lattice phononic subsurface material is finite in length, a truncation (local surface) mode/resonance appears in the spectrum and tends to fall within a stop band. The performance metric is negative to the right of this resonance and therefore the phononic subsurface unit cell may be designed such that this truncation resonance falls to the left of the frequency of the flow wave (or spectra of waves) that is to be stabilized.

Within a pass band, the performance metric oscillates between positive and negative across frequency windows bounded by the finite structure's resonances and antiresonances.

All the points made above for controlling a single flow wave at a particular frequency may be repeated for other flow waves with other frequencies appearing within the flow. One way to implement this multi-frequency strategy is to assemble a stack of lattice subsurface phononic material next to each other, where each lattice phononic subsurface material is designed to cover a particular frequency.

In principle, the structure used to control the flow may be a standard homogenous and uniform elastic structure for which a performance metric can similarly be used to guide the design. An advantage of using a lattice phononic subsurface material, however, is that it is based on intrinsic unit-cell properties and is thus more robust to any changes to the boundary conditions during operation.

Control of flow propagation or properties, for example, may increase wave stability and/or instability depending on design characteristics. For example, stabilization may be accomplished or at least increased within a stop band (or more than one stop band) by inducing destructive interferences in the velocity and/or pressure fields of a flow that lead to attenuation of wave amplitudes (e.g., disturbance/instability wave amplitudes) in the flow at frequencies for which the performance metric is negative. Similarly, flow destabilization may be induced within a pass band (or more than one pass band) by constructive interferences in the velocity and/or pressure fields of a flow that amplify wave amplitudes (e.g., disturbance/instability wave amplitudes) in the flow at frequencies for which the performance metric is positive. Flow destabilization may also occur within a stop band at a frequency falling to the left of the truncation resonance frequency.

In one implementation, for example, a lattice phononic subsurface material may be designed to stabilize an unstable wave at a particular frequency as follows. A unit cell of a lattice phononic subsurface material is designed and optimized to exhibit a stop band (band-gap) encompassing, or at least partially encompassing, the frequency of an instability wave or the range of frequencies of several instability waves. A steady-state frequency response analysis may also be conducted on a model. The steady state frequency response analysis, for example, may include representing a finite structure composed of one or more unit cells of the type designed above. The unit cells may be laid out in a direction perpendicular, at an angle, parallel, or a combination thereof, to the surface (and flow). The unit cell and possibly the end design and boundary conditions of the structure may be altered until a periodicity truncation resonance (or more than one periodicity truncation resonance) that is closest to the instability wave frequency is (are) located as close as possible (or at least reasonably close to) and at least partially to the left of the instability wave frequency. A performance metric may be used to evaluate the predicted performance of the lattice phononic subsurface material as explained in Hussein Mich., Biringen S, Bilal Oreg., Kucala, A. Flow stabilization by subsurface phonons. Proc. R. Soc. A 471: 20140928, which is hereby incorporated by reference in its entirety as if fully set forth herein. The process may be repeated until the predicted performance metric gives a negative value with the highest possible absolute value or at least a significant stabilizing effect.

One advantage of this example approach is that a lattice phononic subsurface material can be fully designed without carrying out any coupled fluid-structure simulations (which tend to be computationally expensive). However, a fluid-structure simulation may be conducted as a verification, especially to ensure that the level of damping (material and structural) in the phononic subsurface is optimal or at least satisfactory for a particular application.

The same process as the one mentioned above may be similarly adopted for destabilization, with the exception that (1) the unit cell in this case is designed to exhibit a pass band around the frequency of interest and (2) the structure overall (including the unit cell layout) is designed such that the frequency of interest matches, or at least overlaps with, a pass-band resonance frequency.

While the above descriptions are concerned with the manipulation of a single frequency (unstable wave for stabilization or vice versa), the methodology can be extended to cover particular frequencies simultaneously and their harmonics (which is relevant to nonlinear instabilities and transition control) and a range of frequencies (which is relevant to turbulence and turbulent flow control).

In one implementation of a flow-related system, for example, one or more lattice phononic subsurface material structures may be designed to control a transition of a fluid from a laminar flow to a turbulent flow. The transition from a laminar flow to a turbulent flow can be delayed by increasing the stability of the flow. Similarly, the transition of the laminar flow to a turbulent flow may be controlled to be earlier than would otherwise be achieved by decreasing the stability of the flow.

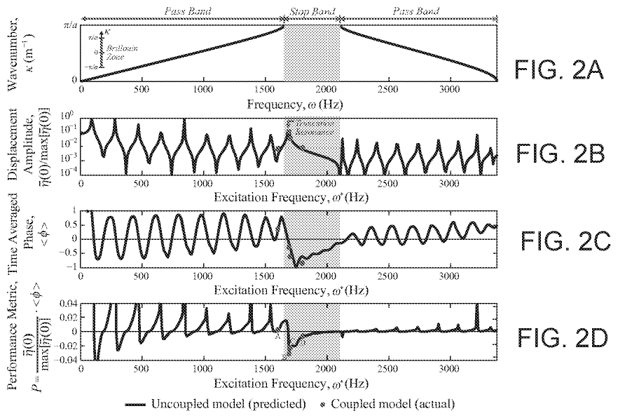

FIG. 2A depicts example dispersion curves fora one-dimensional layered phononic crystal from which the subsurface is composed (Brillouin zone illustrated in inset) as shown in FIG. 1. FIG. 2B depicts an example steady-state vibration response of the phononic crystal surface representing the interface with the flow as shown in FIG. 1. FIG. 2C depicts an example time-averaged phase between force and displacement at the phononic crystal surface representing the interface with the flow as shown in FIG. 1. FIG. 2D depicts an example performance metric combining amplitude and relative phase between the force and the displacement at the phononic crystal surface representing the interface with the flow as shown in FIG. 1. In FIGS. 2B-2D, results obtained by analyzing the phononic crystal alone (without coupling to the flow) are represented by black solid curves. Results from the coupled fluid—structure simulations are represented by dots. In FIG. 2B, the four coupled simulation data points are all multiplied by a single common constant to calibrate with the uncoupled model curve. In one implementation, a lattice phononic subsurface material comprises a lattice structure comprising a plurality of structural elements (e.g., beams, rods, etc.) and voids/holes. The lattice structure disposed adjacent the flow exhibits band gaps for interacting with the flow.

FIGS. 12 and 13 shows example lattice configurations that may be used in a lattice phononic subsurface material such as described herein. In each example configuration, the lattice phononic subsurface material comprises a plurality of structural elements and voids disposed within the phononic subsurface material. The lattice subsurface material may further include a solid surface material disposed adjacent a flow and/or may be disposed adjacent to a flow surface disposed adjacent the flow such as described herein.

In various embodiments, the lattice phononic subsurface material including a lattice structure may comprise a 1D, 2D or 3D structure. A lattice structure phononic may comprise 1D Timoshenko beam structures and voids or other structures. A 2D lattice structure may comprise a triangular honeycomb lattice and, in various implementations, may exhibit bandgaps between relatively low branches.

The lattice structures provide for decreased weight within the phononic subsurface material compared to a similarly arranged solid phononic subsurface material. Further, the presence of the structural elements and the voids provide a response to waves within the flow similar to a relatively deeper solid phononic subsurface material.

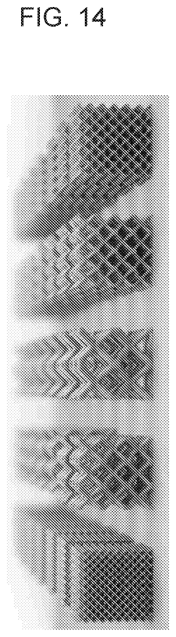

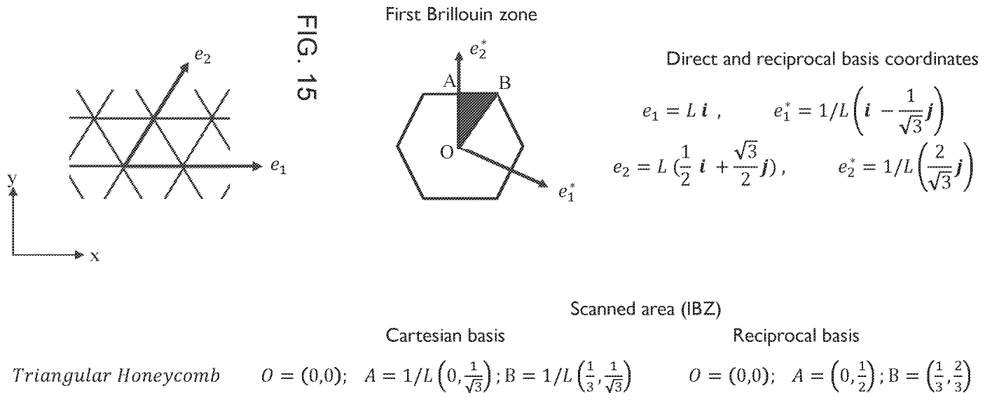

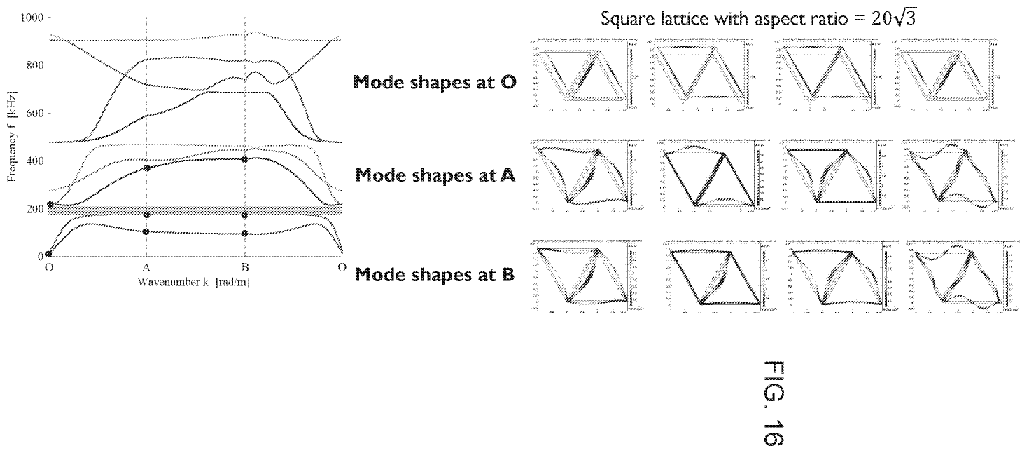

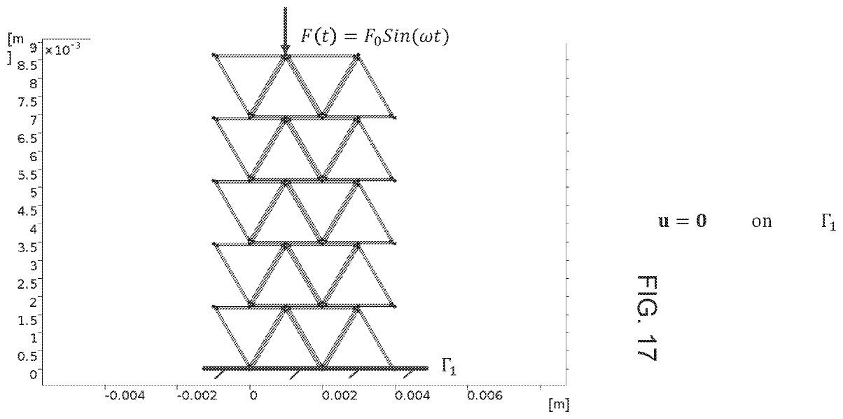

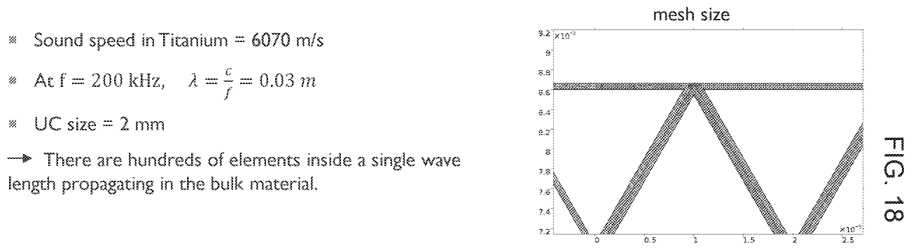

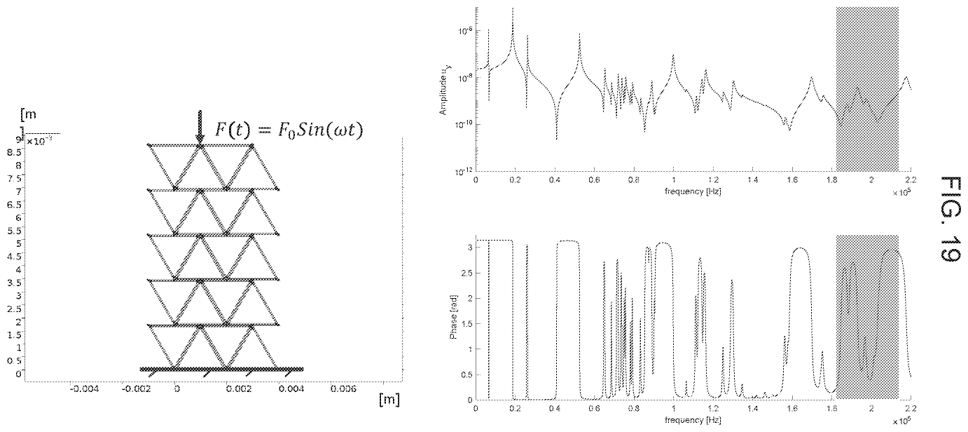

FIG. 14 shows further example 3D lattice structured phononic materials a be used a phononic subsurfaces as described herein.

FIG. 15 shows an example triangular honeycomb lattice structure and a corresponding 2D lattice model that may be used to model the lattice structured phononic subsurface material and its response to a flow adjacent to the phononic subsurface material. In one implementation, for example, periodic boundary conditions may be imposed on a cell of the lattice structure and dispersion curves may be obtained for a unit cell. A frequency response function of a finite structure made of stacked lattice unit cells is obtained and a 2D lattice performance metric is determined. Similarly, performance metrics may be investigated for different lattice structure units and compared to performance metrics for other proposed structures.

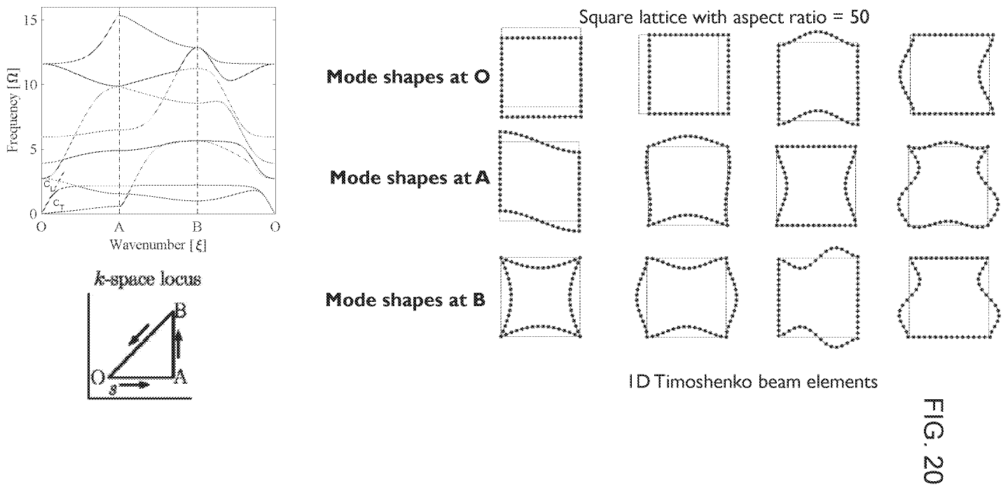

FIG. 16 shows dispersion and mode shapes of an example triangular honeycomb lattice structure such as shown in FIG. 15. In this example embodiment, for example, the modal displacement of the lattice material takes different spatial distributions depending on the frequency and wavevector of the mode.

FIG. 17 shows a graph of an example frequency response for a 2D plane-strain of an embodiment of a lattice structured phononic subsurface material such as the triangular honeycomb lattice structure shown in FIG. 16. In this example embodiment, for example, the lattice phononic structure is excited at top where the structure would interface with the fluid-structure surface, and the response (amplitude and phase) are computed at the same point as a function of excitation frequency. This calculation allows for calculation of a phononic performance metric used to evaluate the ability of the phononic subsurface to stabilize or destabilize the flow a given frequency or a range of frequencies.

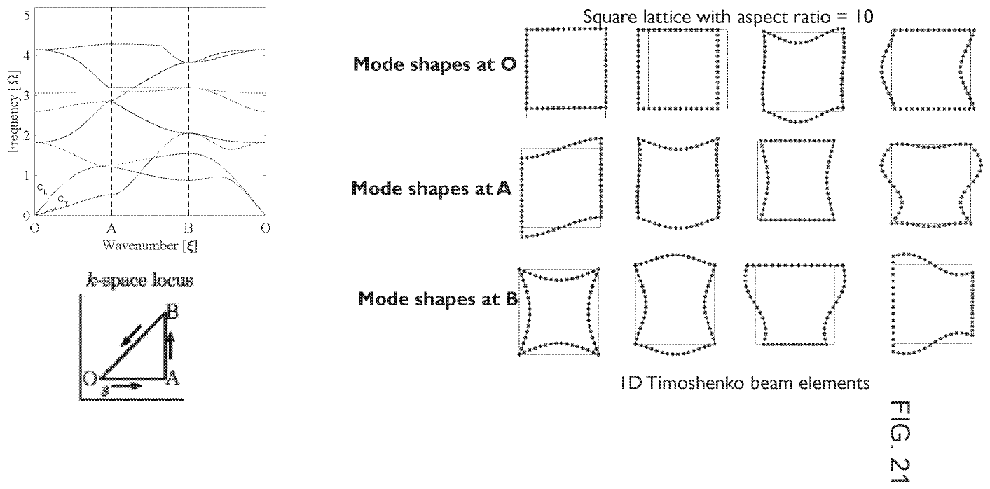

FIG. 18 shows finite element considerations for vibrations at high frequencies. The finite-element method may be used to numerically discretize and model the lattice material unit cell. The higher the upper frequency of the design the higher the finite-element mesh size required to provide accurate results.

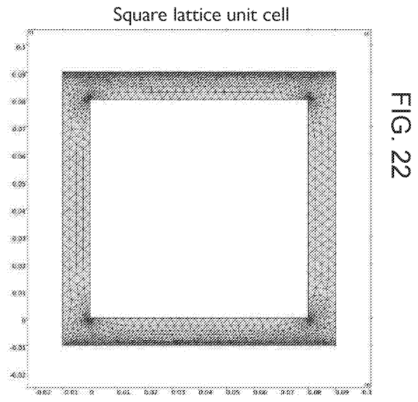

FIG. 19 shows amplitude and phase frequency response for an example 2D lattice structure phononic subsurface material for a force F(t) imparted on the phononic subsurface structure.

FIG. 20 shows dispersion and mode shapes of an example 1D lattice structure phononic subsurface material including 1D Timoshenko beam structural elements with a square lattice having an aspect ratio of 50. In this example embodiment, for example, the modal displacement of the lattice material takes different spatial distributions depending on the frequency and wavevector of the mode

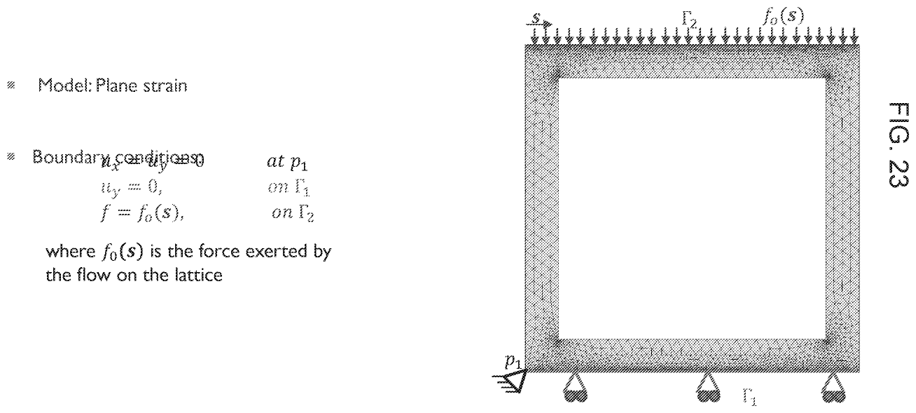

FIG. 21 shows dispersion and mode shapes of an example 1D lattice structure phononic subsurface material including 1D Timoshenko beam structural elements with a square lattice having an aspect ratio of 10. In this example embodiment, for example, the modal displacement of the lattice material takes different spatial distributions depending on the frequency and wavevector of the mode

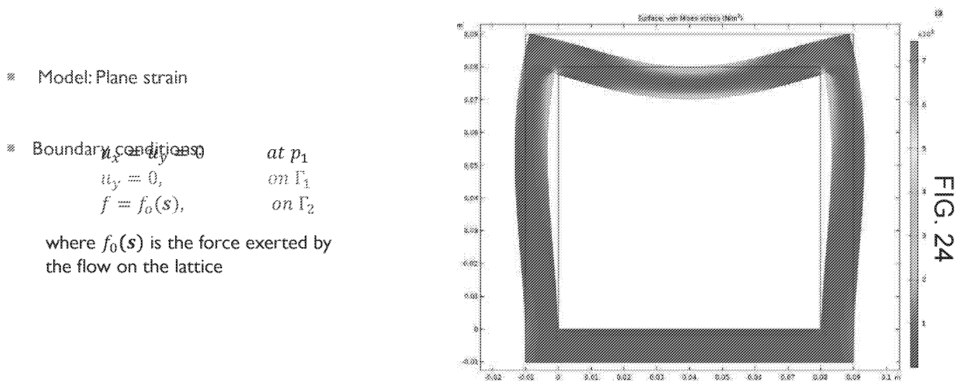

FIGS. 22 and 23 shows a 2D plane strain model for an example lattice structured phononic subsurface structure including a single square lattice unit cell. In this particular embodiment, the lattice structures are modeled with 2D plane strain finite elements. A static response to a distributed load applied to a side of the unit cell is determined. Such static analysis may aid the design for structural integrity which can be compatible with the design of the lattice phononic subsurface for flow stabilization or destabilization.

FIG. 24 shows a static 2D plane strain model for the example lattice structured phononic subsurface structure comprising a single square lattice unit cell. In this particular embodiment, the static displacement distribution is shown.

A lattice structured phononic subsurface structure may be used to reduce drag in laminar flow, delay transition from laminar flow to turbulence, control turbulent flow, and/or reduce temperature spikes in hypersonic flow (e.g., hypersonic flight) by delaying the transition from laminar flow to turbulent flow.

In controlling laminar flow and delaying the transition from laminar flow to turbulent flow, a performance metric, such as described above, may be used to design a phononic subsurface structure. Similarly, effective stiffness of a material may be used to design a phononic subsurface material for controlling turbulent flow and/or hypersonic flow. The phononic subsurface structure may comprise a periodic, at least partially periodic or non-periodic lattice material.

A lattice structured phononic subsurface structure may be used to reduce drag in laminar flow, delay transition from laminar flow to turbulence, control turbulent flow, and/or reduce temperature spikes in hypersonic flow (e.g., hypersonic flight) by delaying the transition from laminar flow to turbulent flow and/or by stabilizing the primary mode of instability, secondary mode of instability, or both the primary and secondary modes of instabilities.

A lattice structured phononic subsurface structure may be used to reduce drag in laminar flow, delay transition from laminar flow to turbulence, control turbulent flow, and/or reduce temperature spikes in hypersonic flow (e.g., hypersonic flight) by delaying the transition from laminar flow to turbulent flow and/or by stabilizing instabilities of different spatial distributions and propagation directions over the surface.

A lattice structured phononic subsurface structure may be used to reduce drag in laminar flow, delay transition from laminar flow to turbulence, control turbulent flow, and/or reduce temperature spikes in hypersonic flow (e.g., hypersonic flight) by delaying the transition from laminar flow to turbulent flow on a flat surface or a curved surface or a cone-shaped surface which may be part of a hypersonic vehicle or hypersonic rocket.

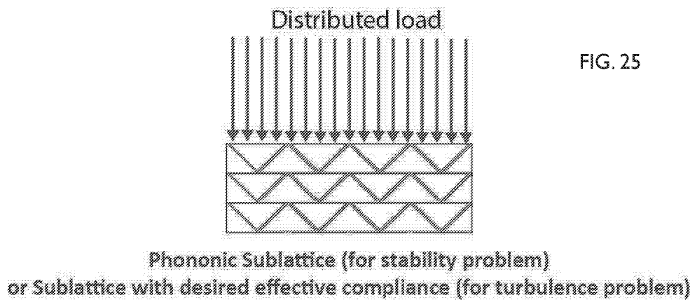

FIG. 25 is a schematic diagram of a distributed load applied to a phononic sublattice designed to provide a subsurface material adapted to affect a flow. The example sublattice shown may be attached to a flow (i.e., placed underneath the surface of a wing exposed to a flow) with a surface of the sublattice interfacing with the flow. As described herein, a plurality of voids and structural members of the phononic sublattice structure may be designed to affect a flow when disposed as a subsurface material adjacent to or juxtaposed to the flow. The distributed load is applied at the design stage to allow us to calculate a performance metric the sublattice to evaluate its ability to stabilize or destabilize the flow (for laminar flows) or evaluate the effective structural compliance of sublattice to evaluate its ability to reduce the turbulence intensity in the flow (for turbulent flow). Flow stabilization in a laminar flow and turbulence intensity reduction in turbulent flow lead to reducing skin-friction drag.

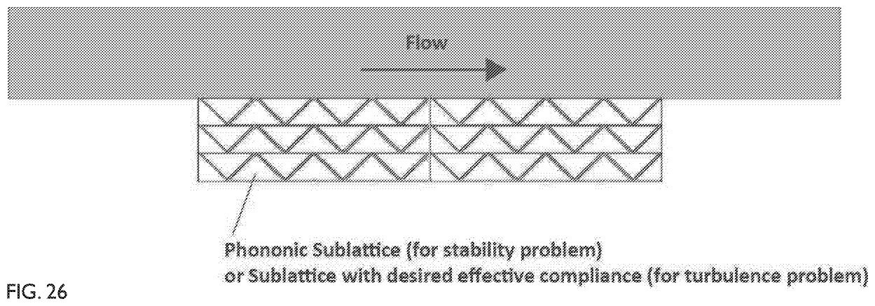

FIG. 26 is a schematic diagram of an example phononic sublattice structure, such as shown in FIG. 25, disposed adjacent or juxtaposed to a flow. In this implementation, The example extended sublattice shown is being interfaced with a flow through a common interfacing surface. For laminar flows, a frequency-dependent performance metric in the form of the product of the amplitude response and the phase response is a key measure in determining the ability of the substructure in stabilizing or destabilizing the flow (such as described in U.S. patent application Ser. No. 14/811,801 filed on Jul. 28, 2015). For turbulent flows, the effective structural compliance of this extended lattice structure, as measured along the vertical direction in this figure, is a key metric in determining the reduction in intensity of turbulence in the flow; higher the effective structure compliance leads to lower the turbulence intensity, which leads to lower the skin-friction drag.

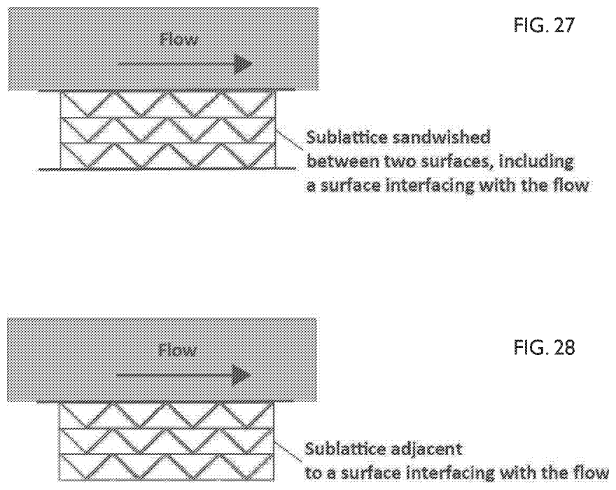

FIG. 27 is schematic diagram of another example phononic sublattice structure, such as shown in FIGS. 25 and 26, disposed adjacent or juxtaposed to a flow. In this implementation, for example, the phononic sublattice structure comprising a plurality of structural members and voids defined by the structural members of the sublattice structure is disposed between a pair of surfaces that may in some examples provide structural support to the sublattice structure. One of the pair of surfaces provides a flow surface disposed adjacent or juxtaposed to a flow and is adapted to interact with the flow as described herein. The example sublattice structure shown is being interface with a flow through a common interfacing surface. For laminar flows, a performance metric in the form of the product of the amplitude response and the phase response is a key measure in determining the ability of the substructure in stabilizing or destabilizing the flow (such as described in U.S. patent application Ser. No. 14/811,801 filed on Jul. 28, 2015). For turbulent flows, the effective structural compliance of the lattice structure, as measured along the vertical direction in this figure, is a key metric in determining the reduction in intensity of turbulence in the flow; higher effective structural compliance leads to lower turbulence intensity, which leads to lower skin-friction drag.

FIG. 28 is a schematic diagram of another example phononic sublattice structure in which the phononic sublattice structure is disposed adjacent to a flow surface adapted to interact with the flow. FIG. 28 is schematic diagram of another example sublattice structure, such as shown in FIGS. 25 and 26, disposed adjacent or juxtaposed to a flow. In this implementation, for example, the sublattice structure comprising a plurality of structural members and voids defined by the structural members of the sublattice structure is disposed under a surface that may in some examples provide structural support to the sublattice structure. This surface provides a flow surface disposed adjacent or juxtaposed to a flow and is adapted to interact with the flow as described herein. The example sublattice structure shown is being interface with a flow through a common interfacing surface. For laminar flows, a performance metric in the form of the product of the amplitude response and the phase response is a key measure in determining the ability of the substructure in stabilizing or destabilizing the flow (such as described in U.S. patent application Ser. No. 14/811,801 filed on Jul. 28, 2015). For turbulent flows. the effective structural compliance of this lattice structure, as measured along the vertical direction in this figure, is a key metric in determining the reduction in intensity of turbulence in the flow; higher effective structure compliance leads to lower turbulence intensity, which leads to lower skin-friction drag.

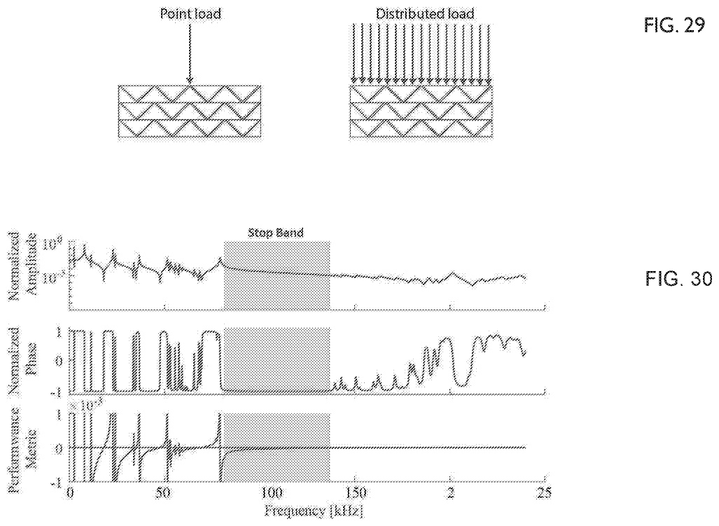

FIG. 29 includes schematic diagrams of a point load and a distributed load applied to a phononic sublattice structure, such as those shown in FIGS. 25-28. As described herein, a plurality of voids and members of the sublattice structure may be designed to provide the desired performance metric (for laminar flow stabilization) or effective structural compliance (for turbulent flow turbulence intensity reduction) of an overall subsurface structure. Either a point load or a distributed load is applied at the design stage to allow us to calculate the performance metric or effective structural compliance of this sublattice. Our published results (Proceedings of the Royal Society A, 471, 20140928 by Hussein et al.) have shown that a negative performance metric value with large amplitude leads to strong flow stabilization and hence reduction in skin-friction drag. Our preliminary results have shown that the higher the effective structural compliance the more effective it is in reducing the intensity of turbulence and hence in reducing skin-friction drag.

In FIGS. 25-29, a triangular internal lattice geometry is used for all the examples provides. Alternatively, other internal lattice geometries may be used; examples include hexagonal honeycomb, triangular honeycomb Kagomé lattice, square honeycomb, among others (see Journal of the Acoustical Society of America, 119(4), April 2006 by Phani et al. for a formal definition of these internal lattice geometries).

FIG. 30 shows frequency dependent amplitude, phase, and performance metric response for the lattice subsurface structure shown in FIG. 29 for a point force F(t) imparted on the lattice subsurface structure.

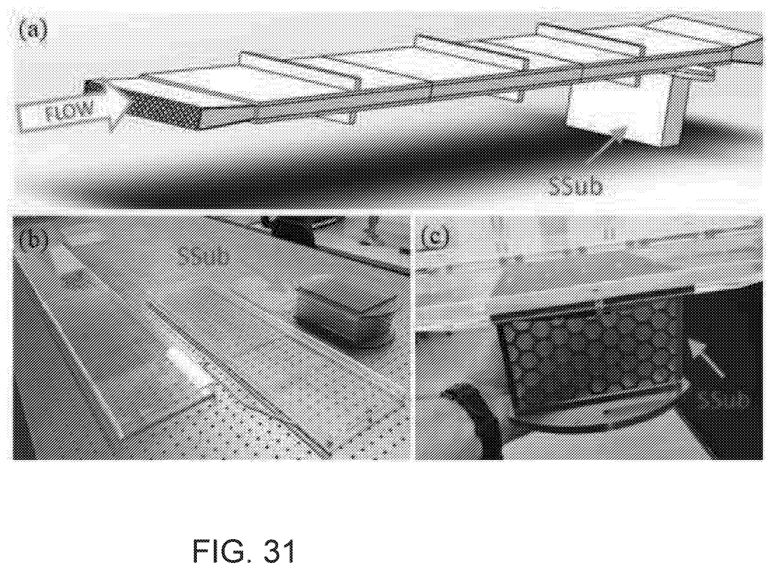

FIG. 31 is a schematic drawing showing a prototype turbulent channel rig that can be used for testing the performance of a an example structural subsurface material such as the example lattice substructure (labeled here as S Sub) shown for the purpose of laminar flow stabilization/destabilization or turbulent flow increase or decrease in intensity of turbulence. FIG. 31 also shows examples of fabricated channel components of the channel rig, and a three-dimensional (3D) printed structural subsurface material labeled as SSub in FIG. 31. In this example, the lattice has a honeycomb internal geometry, although other internal geometries such as those described herein may alternatively be used in the turbulent channel rig.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A material for use in interacting with a fluid or solid flow, the material comprising:
an interface surface adapted to move in response to a pressure exerted on the interface surface by a flow, the pressure being associated with at least one wave having at least one frequency; and
a subsurface feature extending away from the interface surface, the subsurface feature comprising a lattice-structured material comprising a plurality of structural elements that form a plurality of voids, wherein the surface material alters a phase of the at least one wave;
wherein the interface surface is adapted to vibrate at a frequency, phase, and amplitude in response to the altered phase of the at least one wave.

2. The material of claim 1, adapted to control one or more instabilities in the flow when the flow is hypersonic.

3. The material of claim 1, adapted to control one or more instabilities in the flow when the flow is supersonic or subsonic.

4. The material of claim 1, wherein the lattice-structured material further comprises at least one mass adapted to act as a local resonator.

5. The material of claim 1, wherein the subsurface feature forms the interface surface.

6. (canceled)

7. The material of claim 1, wherein the interface surface comprises a surface of a flow channel.

8. (canceled)

9. The subsurface material of claim 1, wherein the subsurface feature comprises one of: a structure that is periodic in three dimensions, a structure that is periodic in two dimensions, and a structure that is periodic in one dimension.

10-11. (canceled)

12. The material of claim 1, wherein the subsurface feature comprises a bulk material.

13. The material of claim 1, wherein the subsurface feature extends in a direction perpendicular to the flow interface surface.

14. The material of claim 1, wherein the subsurface feature extends in a direction parallel to the flow interface surface.

15. The material of claim 1, wherein the subsurface feature alters an effective structural compliance of the flow interface surface relative to the flow such that the flow experiences an alteration in one or both of a surface skin-friction drag and a kinetic energy.

16. The material of claim 15, wherein the alteration comprises a decrease in one or both of the surface skin-surface drag and the kinetic energy.

17-21. (canceled)

22. The material of claim 1, wherein the flow interface has a relative compliance such that the flow interface surface deforms in response to the flow.

23-26. (canceled)

27. The material of any claim 1, wherein the subsurface feature extends in a direction that is perpendicular to a flow direction of the flow.

28. A method of interacting with a flow, comprising:
exerting a pressure from the flow onto an interface surface, the pressure being associated with at least one wave having at least one frequency;
receiving the at least one wave with a subsurface structure extending away from the interface surface, the subsurface structure comprising a lattice material comprising a plurality of structural elements that form a plurality of voids;
altering a phase of the at least one wave with the subsurface structure; and
vibrating the interface surface at a frequency, phase, and amplitude in response to the altered phase of the at least one wave.

29. The method of claim 28, wherein the subsurface structure comprises at least one surface adjoining the lattice material.

30. The method of claim 29, wherein one of the at least one surface forms the interface surface.

31. (canceled)

32. The method of claim 28, wherein the subsurface feature alters an effective structural compliance of the interface surface relative to the flow such that the flow experiences an alteration in one or both of a surface skin-friction drag and a kinetic energy.

33. The method of claim 32, wherein the alteration comprises a decrease in one or both of the surface skin-surface drag and the kinetic energy.

34-36. (canceled)

37. The method of any claim 28, wherein the flow interface surface comprises a surface of a flow channel.

38. (canceled)
